(19) United States
(12) Patent Application Publication
(10) Pub. No.: US 2009/0290471 A1
(43) Pub. Date: Nov. 26, 2009

(54) RECORDING AND REPRODUCING DEVICE, RECORDING AND REPRODUCING METHOD, RECORDING DEVICE, RECORDING METHOD, REPRODUCING DEVICE, AND REPRODUCING METHOD

(75) Inventors: Kenji TANAKA, Tokyo (JP); Atsushi Fukumoto, Kanagawa (JP); Masaaki Hara, Tokyo (JP); Kazutatsu Tokuyama, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/429,883

(22) Filed: Apr. 24, 2009

(30) Foreign Application Priority Data
May 20, 2008 (JP) 2008-132065

(51) Int. Cl. G11B 7/00

(52) U.S. Cl. 369/103; G9B/7

(57) ABSTRACT

A recording and reproducing device performs recording and reproduction on a hologram recording medium on which data is recorded by the use of interference fringes formed by signal light and reference light. The device includes: a light generation device including a spatial light modulator which performs spatial light modulation on incident light, and generating the signal and reference lights in the recording and the reference light in the reproduction; an image sensor for receiving the incident light and obtaining a light reception signal; an optical system for guiding the signal and reference lights to the hologram recording medium and reproduction light to the image sensor; and a band limiting device inserted on a Fourier plane in an optical path of the optical system, and having a transmittance set to be lower in a central area thereof than in a peripheral area thereof, to perform band limitation on the incident light.

### BACKGROUND OF THE INVENTION

1. Field of the Invention

The present invention relates to a recording and reproducing device and a method thereof for performing recording and reproducing operations on a hologram recording medium on which data is recorded by the use of interference fringes formed by signal light and reference light. The present invention further relates to a recording device and a method thereof for performing a recording operation on a hologram recording medium, and a reproducing device and a method thereof for performing a reproducing operation on a hologram recording medium.

2. Description of the Related Art

As described in Japanese Unexamined Patent Application Publication Nos. 2006-107663 and 2007-79438, for example, there has been a hologram recording and reproducing method which records data by the use of interference fringes formed by signal light and reference light and reproduces the data recorded by the use of the interference fringes through the application of the reference light. As the hologram recording and reproducing method, there has been a so-called coaxial method which performs the recording operation with the signal light and the reference light disposed on the same axis.

FIGS. 17 to 18B are diagrams for explaining the coaxial hologram recording and reproducing method. FIG. 17 illustrates the recording method, and FIGS. 18A and 18B illustrate the reproducing method. Firstly, as in FIG. 17, in the recording operation, an SLM (Spatial Light Modulator) 101 performs spatial light modulation (e.g., light intensity modulation) on incident light emitted from a light source, to thereby generate signal light and reference light disposed on the same axis as illustrated in the drawing. The SLM 101 is formed by a liquid crystal panel or the like, for example. In this case, the signal light is generated by spatial light modulation according to recorded data. Further, the reference light is generated by spatial light modulation according to a predetermined pattern.

The signal light and the reference light thus generated by the SLM 101 are subjected to spatial phase modulation by a phase mask 102. As illustrated in the drawing, the phase mask 102 provides the signal light with a random phase pattern, and provides the reference light with a preset predetermined phase pattern.

Herein, the phase modulation is performed on the reference light to enable multiple recording on a hologram recording medium, as described in Japanese Unexamined Patent Application Publication No. 2006-107663. That is, signal light (data) recorded with the use of reference light having a certain phase structure can be read out in the reproducing operation solely by the application of reference light having the same phase structure. Thus, with the application of this technique, data is multiply recorded in the recording operation with the use of reference lights having different phase structures, and the reference lights having the respective phase structures are selectively applied in the reproducing operation. Thereby, the multiply recorded data sets can be selectively read out.

Further, the random phase modulation pattern is provided to the signal light to improve the interference efficiency between the signal light and the reference light and spread the spectrum of the signal light, to thereby suppress DC (Direct Current) components and increase the recording density. The phase modulation pattern provided to the signal light is set to be a random pattern using two values of 0 and π, for example. That is, the phase modulation pattern for the signal light is set to be a random phase modulation pattern set such that one half of the pixels are not phase-modulated (i.e., phase=0) and the other half of the pixels are phase-modulated by π (180°).

In this case, due to the light intensity modulation by the SLM 101, lights respectively modulated to light intensities of 0 and 1 in accordance with the recorded data are generated as the signal lights. As the thus generated signal lights are subjected to the phase modulation with the value 0 or π, lights respectively having values −1, 0, and 1 (+1) as the amplitude of the light wavefront are generated. That is, if a pixel modulated with the light intensity of 1 is subjected to the modulation with the phase 0, the resultant amplitude is 1. If the pixel is subjected to the modulation with the phase π, the resultant amplitude is −1. In the case of a pixel modulated with the light intensity of 0, the amplitude remains to be 0, whether the pixel is subjected to the modulation with the phase 0 or the modulation with the phase π.

For confirmation, FIGS. 19A and 19B show a difference in the signal light and the reference light between an example without the phase mask 102 (FIG. 19A) and an example with the phase mask 102 (FIG. 19B). In FIGS. 19A and 19B, the magnitude relation of the light amplitude is expressed in color density. Specifically, in FIG. 19A, a change in color from black to white represents a change in amplitude from 0 to 1. In FIG. 19B, a change in color from black to gray and then to white represents a change in amplitude from −1 to 0 and then to 1 (+1).

Herein, the signal light is intensity-modulated in accordance with the recorded data. Therefore, the light intensities (amplitudes) 0 and 1 are not necessarily allocated at random, and thus the generation of the DC components is facilitated. The phase pattern provided by the phase mask 102 is a random pattern. Therefore, the pixels having the light intensity of 1 and included in the signal light output from the SLM 101 can be divided at random (into halves) into pixels having the amplitude of 1 and pixels having the amplitude of −1. With the pixels thus divided at random into the pixels having the amplitude of 1 and the pixels having the amplitude of −1, the spectrum can be uniformly spread on a Fourier plane (frequency plane, which in this case can be considered to be an image on a medium). Thereby, the DC components of the signal light can be suppressed.

With the DC components of the signal light thus suppressed, the data recording density can be increased. In this case, if the DC components are generated in the signal light, the recording material reacts largely to the DC components, and thus the above-described multiple recording is hindered. That is, a region recorded with the DC components is prevented from being multiply recorded with further data. If the above-described random phase pattern suppresses the DC components, it is possible to perform the multiple data recording, and thus to increase the recording density.

Returning back to the description of the recording operation, the signal light and the reference light subjected to the phase modulation by the phase mask 102 are both collected by an objective lens 103 and applied to a hologram recording medium HM. Thereby, interference fringes (diffraction grating, i.e., hologram) according to the signal light (recorded image) are formed on the hologram recording medium HM. That is, data is recorded by the formation of the interference fringes.

Subsequently, as illustrated in FIG. 18A, in the reproducing operation, the incident light is first subjected to spatial light modulation (intensity modulation) by the SLM 101 to generate reference light. Then, the thus generated reference light is subjected to spatial light phase modulation by the phase mask 102 to be provided with the same predetermined phase pattern as the phase pattern provided in the recording operation.

In FIG. 18A, the reference light subjected to the phase modulation by the phase mask 102 is applied to the hologram recording medium HM through the objective lens 103. Herein, as described above, the reference light is provided with the same phase pattern as the phase pattern provided in the recording operation. With the above-described reference light applied to the hologram recording medium HM, diffracted light according to the recorded hologram image is obtained and output as reflected light from the hologram recording medium HM, as illustrated in FIG. 18B. That is, a reproduced image (reproduction light) according to the recorded data is obtained.

Then, the thus obtained reproduction light is received by an image sensor 104, such as a CCD (Charge Coupled Device) sensor and a CMOS (Complementary Metal Oxide Semiconductor) sensor, for example. On the basis of a light reception signal from the image sensor 104, the recorded data is reproduced.

Herein, according to the hologram recording and reproducing method described above, the DC components of the signal light are suppressed by the phase mask 102 in the recording operation to increase the recording density. The method using the phase mask 102 as described above achieves an increase in the recording density by enabling multiple recording of hologram pages.

Meanwhile, as another approach for achieving an increase in the recording density, there has been proposed a related art method which reduces the size of the hologram pages. Specifically, as illustrated in the following FIG. 20, an aperture 105 is provided such that the signal light (and the reference light) to be applied to the hologram recording medium HM is incident on the aperture 105 in the recording operation, and that only a portion of the signal light within a predetermined range from the optical axis center is transmitted through the aperture 105. With this configuration, the signal light (hologram pages) recorded on the hologram recording medium HM can be reduced in size. Consequently, it is possible to achieve an increase in the recording density by reducing the area on the medium occupied by the respective hologram pages.

### SUMMARY OF THE INVENTION

Herein, in the above-described method using the aperture 105, if the transmission area of the incident light is reduced, the size of the hologram pages can be reduced. As a result, a further increase in the recording density can be achieved. Such reduction of the transmission area, however, corresponds to a reduction of the passband in terms of the spatial frequency of the incident light (image). Specifically, the narrower the transmission area is made, the more low-frequency band components are transmitted. That is, the aperture 105 acts as a so-called low-pass filter.

FIG. 21 is a diagram showing an example of the intensity distribution of the signal light obtained in an example including the aperture 105. FIG. 21 shows the intensity distribution of the signal light, with the horizontal axis (X) and the vertical axis representing the distance (μm) from the center (0) of the signal light and the light intensity, respectively. This example, the result of which is shown in the drawing, also includes the phase mask 102 using the random binary pattern. As shown in the drawing, in the example including the aperture 105, the light intensity of the signal light is increased in a central area of the signal light (e.g., an area approximately ±100 μm from the point 0 in the drawing). This corresponds to the emphasis of low-frequency band components in terms of the spatial frequency. Meanwhile, in a peripheral area outside the central area, the light intensity is reduced. That is, this indicates the suppression of high-frequency band components.

As described above, in the method of performing the recording operation with the aperture 105, if the transmission area of the aperture 105 is reduced to increase the recording density, the high-frequency components of a recording signal are deteriorated. As a result, there arises an issue of deterioration of a recording signal characteristic.

To address the above-described issue, there has been proposed a related art method which, to properly reproduce data from a signal recorded with high-frequency components thereof deteriorated by the aperture 105, performs equalization processing for emphasizing the high-frequency components on the basis of electrical signal processing on a readout signal obtained from the image sensor 104 in the reproducing operation. When the equalization processing for emphasizing the high-frequency components is thus performed on the basis of the electrical signal processing, however, there arises an issue of nonlinearity of a hologram recording and reproducing system.

Herein, as described in the foregoing FIG. 17, in the recording operation according to the related art hologram recording and reproducing method, the phase modulation (using the values 0 and π) is performed by the phase mask 102 provided on a real-image plane (plane on which an image similar to the image obtained on a modulation plane of the SLM 101 is obtained), and the signal lights respectively having the amplitudes of −1, 0, and 1 are applied to the hologram recording medium HM. As well as the information of the light intensity, the information of the phase can also be recorded on the hologram recording medium HM. Therefore, the information of the amplitude −1 resulting from the modulation with the phase π is directly recorded on the hologram recording medium HM.

However, the information of the phase recorded on the hologram recording medium HM is not detected by the image sensor 104. That is, the amplitude information of −1 resulting from the modulation with the phase π is not detected. In this case, the image sensor 104 detects the light intensity as the absolute value (square value) of the recorded amplitude. Thus, the amplitude −1 recorded with the phase π and the amplitude 1 recorded with the phase 0 are both detected simply as the same light intensity of 1.

As described above, the hologram recording and reproducing system has nonlinearity which allows the medium to record the phase information but prevents the device from detecting the phase information. Due to the above-described issue of nonlinearity, it is considered to be substantially difficult to effectively operate the signal processing on the light reception signal obtained from the image sensor 104. In view of this, it is also considered to be substantially difficult to effectively operate the above-described equalization processing for emphasizing the high-frequency components. Specifically, it is necessary for effective operation of the above-described equalization processing to perform substantially complicated arithmetic processing in consideration of the nonlinearity described above. As a result, an increase in the circuit size, the device size, and the production cost is caused to present a significant obstacle to the realization of the device.

Meanwhile, even if the attempt to increase the recording density by the use of the aperture 105 is not made, the high-frequency components of the recording signal may be similarly deteriorated. Herein, if the coaxial method described in the foregoing FIGS. 17 to 18B is employed, the signal light and the reference light are disposed on the same axis. In the recording operation, therefore, the signal light and the reference light are collected on the hologram recording medium HM through the same objective lens 103. In this case, the reference light is collected on the hologram recording medium HM through the objective lens 103, and thus has an intensity distribution on the hologram recording medium HM.

Specifically, the reference light in this case has the intensity distribution as shown in the following FIG. 22. FIG. 22 shows an example of the intensity distribution of the reference light, with the horizontal axis (X) and the vertical axis representing the distance (μm) from the center (0) of the reference light and the light intensity, respectively. As obvious from the drawing, also in the reference light, the light intensity is increased in a central area approximately ±100 μm from the center, for example, and is reduced in a peripheral area outside the central area.

With the reference light having the above-described intensity distribution, a signal emphasized in the central area and suppressed in the peripheral area is also recorded as the recording signal (hologram pages) recorded by the use of the interference fringes formed by the signal light and the reference light. As a result, the recording signal characteristic is deteriorated also in this case with the high-frequency components of the recording signal deteriorated. Further, in the reproducing operation, the amount of ambient light of the reproduction light obtained in accordance with the application of the reference light is suppressed. Also in this regard, the signal characteristic is deteriorated.

For confirmation, the above-described issue of the reference light naturally arises also in the example using the aperture 105. That is, if the attempt to increase the recording density by using the aperture 105 is made in the example using the coaxial method, the signal deterioration due to the provision of the aperture 105 and the signal deterioration due to the intensity distribution of the reference light are both caused.

The present invention has been made to address the issue of deterioration of the signal characteristic accompanying the deterioration of the high-frequency band components, which occurs when the coaxial method is employed as the hologram recording and reproducing method or when an attempt is made to increase the recording density by reducing the size of the signal light, as described above. In addressing the above-described issue, it is desirable to improve the recording signal characteristic in the recording operation, or to improve the reproduction signal characteristic in the reproducing operation.

In view of the above circumstances, a recording and reproducing device according to an embodiment of the present invention performs recording and reproducing operations on a hologram recording medium on which data is recorded by the use of interference fringes formed by signal light and reference light. The recording and reproducing device is configured to include light generation means, an image sensor, an optical system, and band limiting means. The light generation means includes a spatial light modulator which performs spatial light modulation on incident light in units of pixels, and generates the signal light and the reference light in the recording operation and generates the reference light in the reproducing operation. The image sensor is configured to receive the incident light in units of pixels and obtain a light reception signal. The optical system is configured to guide to the hologram recording medium the signal light and the reference light generated by the light generation means, and to guide to the image sensor reproduction light obtained from the hologram recording medium in accordance with the application of the reference light in the reproducing operation. The band limiting means is inserted at a position on a Fourier plane in an optical path of the optical system, and has a transmittance set to be lower in a central area thereof than in a peripheral area thereof, to perform band limitation on the incident light.

Further, a recording device according to an embodiment of the present invention performs a recording operation on a hologram recording medium on which data is recorded by the use of interference fringes formed by signal light and reference light. The recording device is configured to include light generation means, an optical system, and band limiting means. The light generation means includes a spatial light modulator which performs spatial light modulation on incident light in units of pixels, and generates the signal light and the reference light. The optical system is configured to guide to the hologram recording medium the signal light and the reference light generated by the light generation means. The band limiting means is inserted at a position on a Fourier plane in an optical path of the optical system, and has a transmittance set to be lower in a central area thereof than in a peripheral area thereof, to perform band limitation on the incident light.

Further, a reproducing device according to an embodiment of the present invention performs a reproducing operation on a hologram recording medium on which data is recorded by the use of interference fringes formed by signal light and reference light. The reproducing device is configured to include light generation means, an image sensor, an optical system, and band limiting means. The light generation means generates the reference light. The image sensor is configured to receive incident light in units of pixels and obtain a light reception signal. The optical system is configured to guide to the hologram recording medium the reference light generated by the light generation means, and to guide to the image sensor reproduction light obtained from the hologram recording medium in accordance with the application of the reference light. The band limiting means is inserted at a position on a Fourier plane in an optical path of the optical system, and has a transmittance set to be lower in a central area thereof than in a peripheral area thereof, to perform band limitation on the incident light.

Further, a recording and reproducing device according to an embodiment of the present invention performs recording and reproducing operations on a hologram recording medium on which data is recorded by the use of interference fringes formed by signal light and reference light. The recording and reproducing device is configured to include light generation means, an image sensor, an optical system, and band limiting means. The light generation means includes a spatial light modulator which performs spatial light modulation on incident light in units of pixels, and generates the signal light and the reference light in the recording operation and generates the reference light in the reproducing operation. The image sensor is configured to receive the incident light in units of pixels and obtain a light reception signal. The optical system is configured to guide to the hologram recording medium the signal light and the reference light generated by the light generation means, and to guide to the image sensor reproduction light obtained from the hologram recording medium in accordance with the application of the reference light in the reproducing operation. The band limiting means is inserted at a position on a Fourier plane in an optical path of the optical system, and performs spatial light phase modulation on the incident light to perform band limitation on the light reception signal obtained at the image sensor.

Further, a reproducing device according to an embodiment of the present invention performs a reproducing operation on a hologram recording medium on which data is recorded by the use of interference fringes formed by signal light and reference light. The reproducing device is configured to include light generation means, an image sensor, an optical system, and band limiting means. The light generation means generates the reference light. The image sensor is configured to receive incident light in units of pixels and obtain a light reception signal. The optical system is configured to guide to the hologram recording medium the reference light generated by the light generation means, and to guide to the image sensor reproduction light obtained from the hologram recording medium in accordance with the application of the reference light. The band limiting means is inserted at a position on a Fourier plane in an optical path of the optical system, and performs spatial light phase modulation on the incident light to perform band limitation on the light reception signal obtained at the image sensor.

As described above, in the embodiments of the present invention, at a necessary position on a Fourier plane (frequency plane) in the optical system for performing the recording operation and/or the reproducing operation on the hologram recording medium, the band limitation of the incident light is performed by the band limiting means having the transmittance set to be lower in the central area thereof than in the peripheral area thereof. With the band limitation thus performed by the band limiting means having the transmittance set to be lower in the central area thereof than in the peripheral area thereof, it is possible to attenuate the low-frequency band components more than the high-frequency band components in the incident light (image) In other words, the high-frequency band components can be emphasized. Further, in the embodiments of the present invention, the above-described band limitation of the incident light on the Fourier plane is performed at a necessary position in an optical path of the optical system. According to this configuration, the above-described emphasis of the high-frequency band components can be performed on either one of the signal light (and the reference light) applied to the hologram recording medium in the recording operation and the reproduction light guided to the image sensor in the reproducing operation. If the emphasis of the high-frequency components is performed on the signal light (and the reference light) in the recording operation, the recording signal characteristic can be improved. Further, if the emphasis of the high-frequency components is performed on the reproduction light, the characteristic of a readout signal (reproduction signal characteristic) obtained at the image sensor can be improved.

Further, in the embodiments of the present invention, the spatial light phase modulation of the incident light is performed on a Fourier plane. As described later, with the phase modulation of the incident light performed on the Fourier plane, the band limitation can be performed on the light reception signal obtained at the image sensor. That is, according to the embodiments of the present invention, which perform the band limitation based on the phase modulation as described above, the reproduction signal characteristic can be improved.

As described above, according to the embodiments of the present invention, at a necessary position on a Fourier plane in the optical system for performing the recording operation and/or the reproducing operation on the hologram recording medium, the band limitation of the incident light is performed by the band limiting means having the transmittance set to be lower in the central area thereof than in the peripheral area thereof, or the spatial light phase modulation of the incident light is performed. Accordingly, it is possible to improve the signal characteristic, which has been considered to be deteriorated when an attempt is made to increase the recording density by reducing the size of the signal light with the use of an aperture or when the coaxial method is employed, for example.

### BRIEF DESCRIPTION OF THE DRAWINGS

FIG. 1 is a diagram illustrating an internal configuration of a recording and reproducing device according to a first embodiment of the present invention;

FIG. 2 is a diagram for explaining respective areas of a reference light area, a signal light area, and a gap area set in a spatial light modulator (SLM);

FIG. 3 is a diagram for explaining a structure of an optical equalizer which performs equalization based on intensity modulation;

FIGS. 4A to 4C are diagrams for explaining the equalization performed by the optical equalizer;

FIGS. 5A and 5B are diagrams showing respective simulation results of the intensity distribution of recording light obtained before and after the equalization by the optical equalizer;

FIGS. 6A and 6B are diagrams showing simulation results of a reproduction signal characteristic;

FIG. 7 is a diagram illustrating an internal configuration of a recording and reproducing device according to a second embodiment;

FIG. 8 is a diagram illustrating an internal configuration of a recording and reproducing device according to a third embodiment;

FIG. 9 is a diagram for explaining a structure of an optical equalizer included in a recording and reproducing device according to a fourth embodiment;

FIG. 10 is a diagram illustrating a simplified model of a hologram reproducing system;

FIG. 11 is a diagram illustrating a model of a reproducing system for performing equalization by the use of an optical equalizer;

FIGS. 12A and 12B are diagrams illustrating an intensity distribution and an equalization characteristic of reproduction light;

FIGS. 13A and 13B are diagrams illustrating an intensity distribution and an equalization characteristic based on intensity modulation of reproduction light;

FIGS. 14A and 14B are diagrams illustrating an intensity distribution and an equalization characteristic based on phase modulation of reproduction light;

FIG. 15 is a diagram illustrating a structure of an optical equalizer as a modified example;

FIG. 16 is a diagram illustrating an internal structure of a recording and reproducing device as a modified example which performs recording and reproducing operations on a transmission-type medium;

FIG. 17 is a diagram for explaining a related art recording method;

FIGS. 18A and 18B are diagrams for explaining a related art reproducing method;

FIGS. 19A and 19B are diagrams showing, for comparison, respective amplitudes of signal light and reference light in an example with a phase mask and an example without a phase mask;

FIG. 20 is a diagram for explaining a recording method using an aperture;

FIG. 21 is a diagram showing an example of the intensity distribution of signal light in an example including an aperture; and

FIG. 22 is a diagram showing an example of the intensity distribution of reference light in an example using a coaxial method.

### DESCRIPTION OF THE PREFERRED EMBODIMENTS

Preferred embodiments (hereinafter referred to as embodiments) for implementing the present invention will be described below.

### First Embodiment

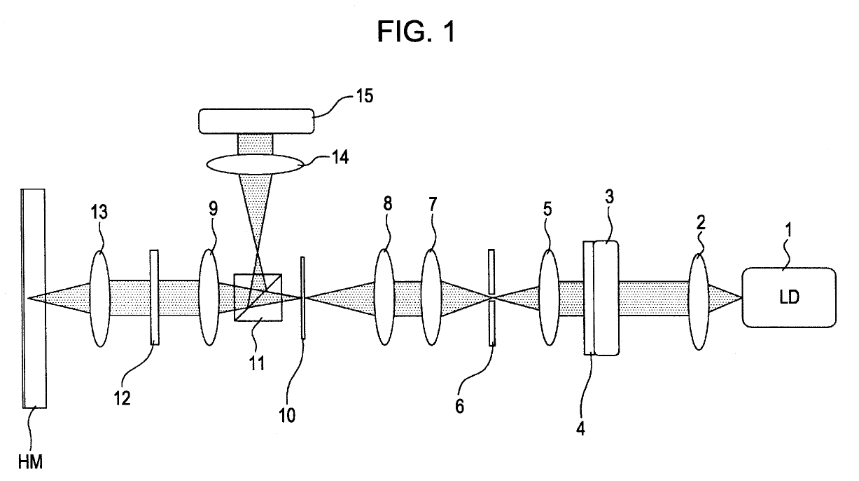

Configuration of Recording and Reproducing Device: FIG. 1 is a diagram illustrating an internal structure of a recording and reproducing device according to an embodiment of the present invention. In FIG. 1, only the configuration of an optical system of the recording and reproducing device is mainly extracted and illustrated, and other parts are omitted.

Firstly, an example using a so-called coaxial method as a hologram recording and reproducing method is presented in the present embodiment. As described earlier, the coaxial method is a method which disposes signal light and reference light on the same axis and applies the lights to a hologram recording medium set at a predetermined position to record data by using interference fringes, and which applies the reference light to the hologram recording medium in a reproducing operation to obtain reproduction light of the data recorded by the use of the interference fringes. Further, the recording and reproducing device of the present embodiment is configured to be compatible with a reflection-type hologram recording medium including a reflective film as a hologram recording medium HM illustrated in the drawing.

In FIG. 1, a laser diode (LD) 1 is provided as a light source for obtaining laser light for the recording and reproducing operations. As the laser diode 1, a laser diode having an external resonator, for example, is used. The wavelength of the laser light is set to be approximately 410 nm, for example. The light emitted from the laser diode 1 is transmitted through a collimator lens 2, and thereafter is incident on an SLM (Spatial Light Modulator) 3.

The SLM 3 is formed by a transmission-type liquid crystal panel, for example. The respective pixels of the SLM 3 are drive-controlled by drive signals output by a not-illustrated drive circuit. Thereby, spatial light intensity modulation (hereinafter occasionally referred to simply as intensity modulation) of the incident light is performed in units of pixels. Specifically, the SLM 3 in this case is configured to turn ON or OFF the incident light (i.e., modulate the light intensity to 1 or 0) in units of pixels.

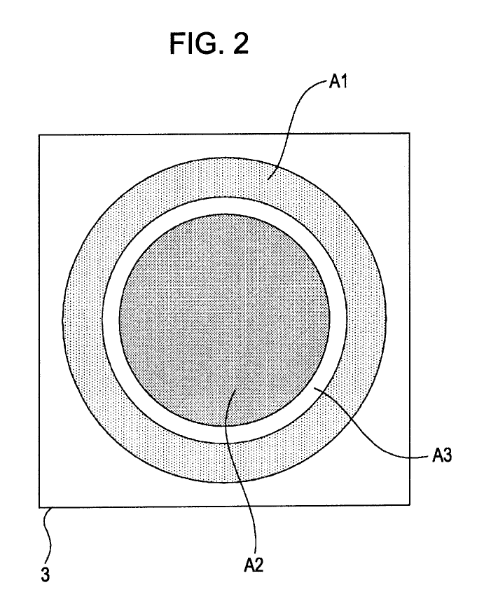

Herein, respective areas of a reference light area A1, a signal light area A2, and a gap area A3 as illustrated in the following FIG. 2 are set in the SLM 3 to generate the reference light and the signal light as separate lights, as described later. Specifically, in the SLM 3 in this case, the signal light area A2 is set to be a predetermined pixel area of a substantially circular shape including a central portion of the SLM 3. The gap area A3 is set to be a predetermined pixel area of a substantially ring shape adjacent to the outer circumference of the signal light area A2. Further, the reference light area A1 is set to be a predetermined pixel area of a substantially ring shape adjacent to the outer circumference of the gap area A3.

Referring back to FIG. 1, light generated by the intensity modulation by the SLM 3 is output through a phase mask 4 attached to the output surface side of the SLM 3. The phase mask 4 is provided to provide the light input through the SLM 3 with a preset predetermined phase pattern. Specifically, the phase mask 4 performs spatial light phase modulation (hereinafter referred to simply as phase modulation) by providing, in units of pixels, the light transmitted through the signal light area A2 of the SLM 3 (signal light) with a random phase pattern using two values of 0 and π, and by providing, in units of pixels, the light transmitted through the reference light area A1 with a predetermined phase pattern. The phase mask 4 is configured to have a cross-sectional structure having concavities and convexities, for example, to perform the phase modulation on the incident light by using differences in optical path length caused by the concavities and convexities. That is, the phase mask 4 is configured to be able to provide, in accordance with the setting of the physical structure pattern thereof, a predetermined phase pattern to the incident light.

The light transmitted through the phase mask 4 is incident on a relay lens 5. Thereby, the light is collected to be focused at a predetermined position, as illustrated in the drawing. Thereafter, the collected light is diffused and incident on a relay lens 7 to be converted into parallel light.

Further, an aperture 6 is provided at a focus position formed by the collection of light by the relay lens 5, i.e., a position on a Fourier plane (frequency plane). The aperture 6 is configured to transmit therethrough only incident light within a predetermined range from the optical axis center. In the recording operation, the aperture 6 reduces the size of the signal light to increase the recording density.

The light transmitted through the relay lens 7 is transmitted through a relay lens 8 to be again collected and focused at a predetermined position. Then, the collected light is diffused and transmitted through a polarizing beam splitter 11, as illustrated in the drawing, and is incident on a relay lens 9 to be converted into parallel light.

Herein, an optical equalizer 10 is provided at a focus position (Fourier plane) formed through the relay lens 8. The optical equalizer 10 will be described in detail later.

The light transmitted through the relay lens 9 is transmitted through a quarter-wave plate 12, collected by an objective lens 13, and applied to the hologram recording medium HM.

Herein, in the recording operation, the above-described SLM 3 performs the intensity modulation on the incident light in the following manner. That is, in the recording operation, in accordance with the drive signals output by the above-described drive circuit, the SLM 3 is driven to turn ON or OFF the respective pixels within the signal light area A2 in accordance with recorded data. Thereby, in the signal light area A2, the light intensity of each of the pixels is modulated to 1 or 0 in accordance with the recorded data. Further, the SLM 3 is driven to turn ON or OFF (1 or 0) the respective pixels within the reference light area A1 in accordance with the preset predetermined pattern. Further, the SLM 3 is driven to turn OFF (light intensity of 0) all pixels within the gap area A3 and the outer circumferential area outside the reference light area A1. With the above-described intensity modulation by the SLM 3, the signal light and the reference light are generated in the recording operation.

Further, the above-described phase mask 4 provides the signal light generated by the SLM 3 with the random phase pattern using the values of 0 and π, and provides the reference light with the predetermined phase pattern.

Then, the thus phase-modulated signal light and reference light are collected on the hologram recording medium HM through the above-described path. Thereby, the data is recorded on the hologram recording medium HM by the use of the interference fringes formed by the signal light and the reference light.

Herein, the signal light is provided with the ransom phase pattern. Thus, the light of pixels modulated to the light intensity of 1 is modulated to the amplitude of 1 (+1) or −1. Further, the number of pixels having the amplitude of 1 and the number of pixels having the amplitude of −1 are set to be substantially the same. Accordingly, the interference efficiency between the signal light and the reference light is improved, and DC components of the signal light are suppressed. Due to the suppression of the DC components, multiple recording of hologram pages can be performed, and the recording density is increased.

Meanwhile, in the reproducing operation, the SLM 3 is driven to bring the pixels within the reference light area A1 into a predetermined ON or OFF pattern, and to turns OFF all of the other pixels. That is, the SLM 3 is driven to generate only the reference light. The reference light thus generated in the reproducing operation receives from the phase mask 4 the same phase pattern as the phase pattern provided in the recording operation, and is applied to the hologram recording medium HM through the above-described path. As the reference light thus provided with the same phase pattern as the phase pattern provided in the recording operation is applied to the hologram recording medium HM, diffracted light according to the interference fringes (recorded data) formed on the hologram recording medium HM is obtained as the reproduction light.

The thus obtained reproduction light (reproduced image) is returned toward the recording and reproducing device as reflected light from the hologram recording medium HM, sequentially transmitted through the objective lens 13, the quarter-wave plate 12, and the relay lens 9, and incident on the polarizing beam splitter 11. The reproduction light incident on the polarizing beam splitter 11 is reflected by the polarizing beam splitter 11 and guided to an image sensor 15 through a lens 14, as illustrated in the drawing. Herein, the reproduction light transmitted through the relay lens 9 converges to be focused at the focus position on the Fourier plane on which the optical equalizer 10 is provided. Therefore, the reproduction light transmitted through the relay lens 9 and reflected by the polarizing beam splitter 11 is collected at a predetermined position as a focus position, as illustrated in the drawing. Thereafter, the collected light is diffused, converted into parallel light by the lens 14, and incident on the image sensor 15.

The image sensor 15 includes an imaging device, such as a CCD (Charge Coupled Device) sensor and a CMOS (Complementary Oxide Semiconductor) sensor, for example. The image sensor 15 receives the reproduction light guided from the hologram recording medium HM in the above-described manner, and converts the reproduction light into an electrical signal. Thereby, a light reception signal (image signal) representing the light intensity detection result of the reproduction light (recorded image) is obtained in the reproducing operation. That is, a readout signal (reproduction signal) of the recorded data is obtained.

Optical Equalizer: Herein, in the recording and reproducing device of the present embodiment, the aperture 6 is provided as described above to reduce the size of the signal light (the size of the hologram pages), to thereby increase the recording density. As described earlier, however, the reduction of the transmission area for the incident light in the aperture 6 for reducing the size of the signal light corresponds to the band limitation for transmitting only low-frequency band components. That is, in terms of the spatial frequency, the aperture 6 acts as a low-pass filter. In this regard, in the case using the method of performing the recording operation with the aperture 6, if the transmission area of the aperture 6 is reduced to increase the recording density, the high-frequency band components of the recording signal are deteriorated. As a result, there arises an issue of deterioration of the recording signal characteristic.

To address the above-described issue, there has been proposed a related art method which performs equalization processing for emphasizing the high-frequency components on the basis of electrical signal processing on the readout signal obtained from the image sensor 15. However, in the case using the method of performing the recording operation by performing the phase modulation on the signal light through the phase mask 4, as in the present embodiment, it is substantially difficult to perform such electrical equalization processing due to the issue of nonlinearity of a hologram recording and reproducing system. That is, it is necessary for effective operation of such electrical equalization processing to perform substantially complicated arithmetic processing in consideration of the nonlinearity. As a result, an increase in the circuit size, the device size, and the production cost is caused to present a significant obstacle to the realization of the device.

Further, even if the attempt to increase the recording density by using the aperture 6 is not made, a similar phenomenon may occur in which the high-frequency components of the recording signal are deteriorated. That is, in the case using the coaxial method, as in the present embodiment, the signal light and the reference light are disposed on the same axis. In the recording operation, therefore, the signal light and the reference light are collected on the hologram recording medium HM through the same objective lens 13. In this case, due to the collection of the reference light on the hologram recording medium HM through the objective lens 13, the reference light has an intensity distribution on the hologram recording medium HM.

Specifically, as shown in the foregoing FIG. 22, in the intensity distribution of the reference light in this case, the light intensity is increased in the central area and reduced in the peripheral area outside the central area. With the reference light having such an intensity distribution, the emphasis in the central area and the suppression in the peripheral area also occur in the hologram pages recorded by the use of the interference fringes formed by the signal light and the reference light. As a result, also in this case, the high-frequency components of the recording signal are deteriorated, and thus the recording signal characteristic is deteriorated. Further, if the reference light having such an intensity distribution is applied in the reproducing operation, the high-frequency components of the reproduction light are suppressed. Also in this regard, the deterioration of the signal characteristic is promoted.

The above-described issue of the reference light naturally arises also in the case using the aperture 6. That is, as described in FIG. 1, if the attempt to increase the recording density by using the aperture 6 is made in the case using the coaxial method, the signal deterioration due to the provision of the aperture 6 and the signal deterioration due to the intensity distribution of the reference light are both caused. Such signal deterioration is significantly disadvantageous in terms of the signal characteristic.

In view of the above-described issues, the present embodiment improves the spatial frequency characteristic by using the optical equalizer 10 inserted at a position on a Fourier plane in an optical path. Specifically, in the first embodiment, the optical equalizer 10 improves the spatial frequency characteristic of recording light (the signal light and the reference light) applied to the hologram recording medium HM in the recording operation.

As understood from the description in the foregoing FIG. 1, in the first embodiment, the optical equalizer 10 is provided on the Fourier plane in front of the polarizing beam splitter 11 as viewed from the laser diode 1 serving as the light source. In other words, the optical equalizer 10 is provided on a Fourier plane in an optical path other than an optical path through which the reproduction light is guided to the image sensor 15 in the reproducing operation. With this configuration, the equalization by the optical equalizer 10 acts only on the signal light and the reference light applied in the recording operation.

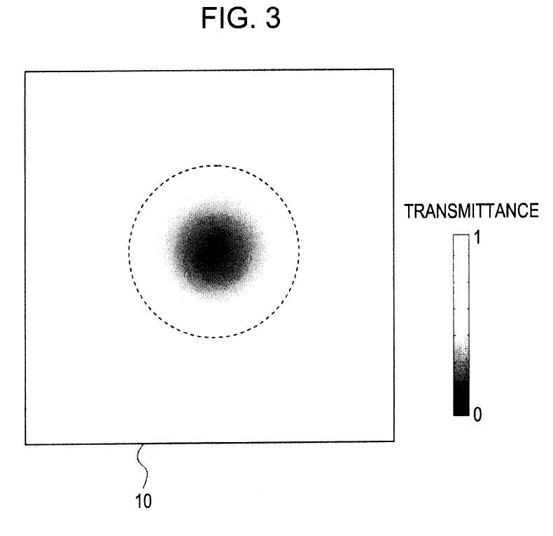

In FIG. 3, which is a diagram for explaining the structure of the optical equalizer 10, the transmittance set in the optical equalizer 10 is shown in color density. Specifically, it is shown in this case that the transmittance is reduced from 1 to 0 as the color changes from white to black. Firstly, in FIG. 3, the range surrounded by a broken line in the drawing represents an area in which the transmittance is actually changed, i.e., a modulation area. As obvious from the drawing, the modulation area indicated by the broken line is set to include the center of the optical equalizer 10. Herein, the optical equalizer 10 is provided with the center thereof positioned to match the optical axis center of the incident light. Therefore, the incident light within a predetermined range including the center thereof is subjected to modulation with a transmittance other than 1.

Specifically, in the optical equalizer 10 in this case, the transmittance in the modulation area is set to be gradually (continuously) reduced toward the center of the area. With this setting of the transmittance in the modulation area, an incident light reducing characteristic is obtained which attenuates the light amount toward the optical axis center and mitigates the light attenuation amount away from the optical axis center.

For confirmation, the optical equalizer 10 can be realized by, for example, a structure in which a light-blocking paint is applied to a transparent substrate with different densities. Alternatively, it is also conceivable to realize the optical equalizer 10 by a structure in which a substrate is formed with materials of different transmittances dispersed from a central area toward a peripheral area thereof.

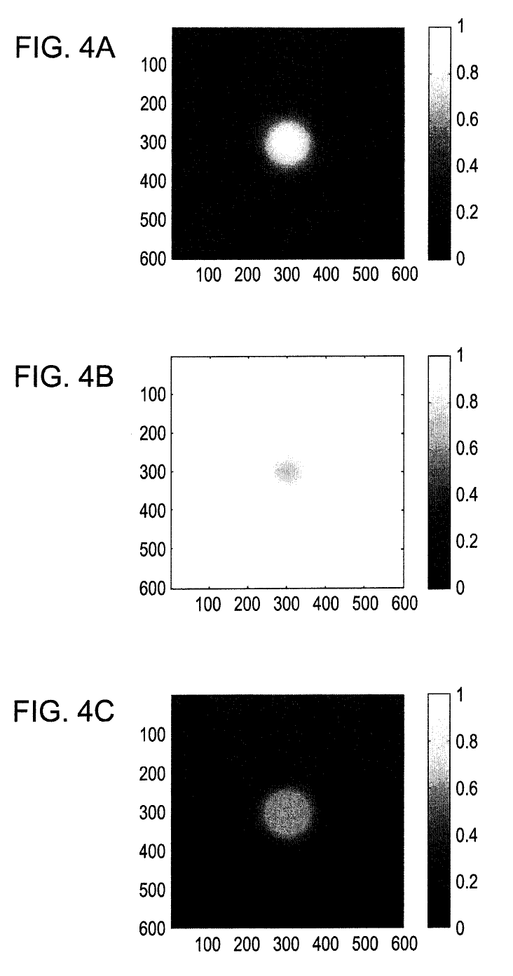

FIGS. 4A to 4C are diagrams for explaining the optical equalization performed by the optical equalizer 10 illustrated in FIG. 3. FIG. 4A shows the light intensity of the recording light (the signal light and the reference light) incident on the optical equalizer 10. FIG. 4B shows the equalizer characteristic (transmittance characteristic). FIG. 4C shows the light intensity of the recording light subjected to the equalization. These drawings show simulation calculation results of the respective cases. FIGS. 4A and 4C show the light intensity in color density, and show a reduction in light intensity from 1 to 0 in accordance with a change in color from white to black. Further, FIG. 4B shows the transmittance in color density, and shows a reduction in transmittance (from 1 to 0) in accordance with a change in color from white to black.

As illustrated in FIG. 4A, it can be confirmed that, in the recording light before incidence on the optical equalizer 10, the light intensity is substantially high in the central area and substantially low in the peripheral area. The recording light as shown in FIG. 4A is subjected to the equalization by the optical equalizer 10 with the characteristic of relatively reducing the transmittance in the central area, as shown in FIG. 4B. Thereby, the recording light subjected to the equalization has the light intensity as shown in FIG. 4C. That is, it is observed from the comparison between FIGS. 4A and 4C that, in the recording light subjected to the equalization, the light intensity is suppressed (attenuated) in the central area and relatively emphasized in the peripheral area, i.e., the light intensity is uniformized.

With the light intensity thus attenuated in the central area and relatively increased in the peripheral area, the attenuation of the low-frequency band components and the emphasis of the high-frequency band components occur in terms of the spatial frequency. That is, with this equalization, it is possible to emphasize the high-frequency components of the recording light applied to the hologram recording medium HM, and thus to improve the recording signal characteristic.

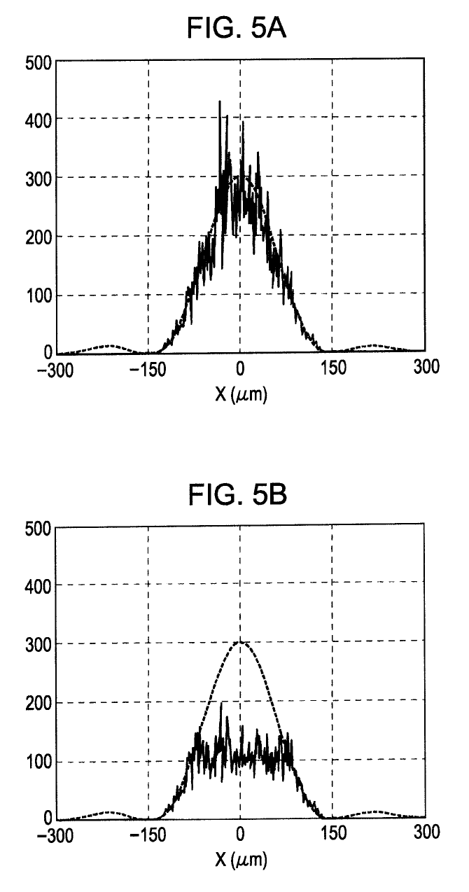

FIGS. 5A and 5B show, as data for proving the above description, respective simulation results of the intensity distribution of the recording light obtained before and after the equalization by the optical equalizer 10 of the present example. FIG. 5A shows the result obtained before the equalization, and FIG. 5B shows the result obtained after the equalization. Each of the drawings shows the intensity distribution of the recording light, with the horizontal axis (X) and the vertical axis representing the distance (μm) from the optical axis center (0) and the light intensity, respectively. For convenience of illustration, each of the drawings shows a profile formed by average values each calculated for every five pixels.

As obvious from the comparison between FIGS. 5A and 5B, the equalization by the optical equalizer 10 attenuates the light intensity in the central area and thus relatively increases the light intensity in the peripheral area.

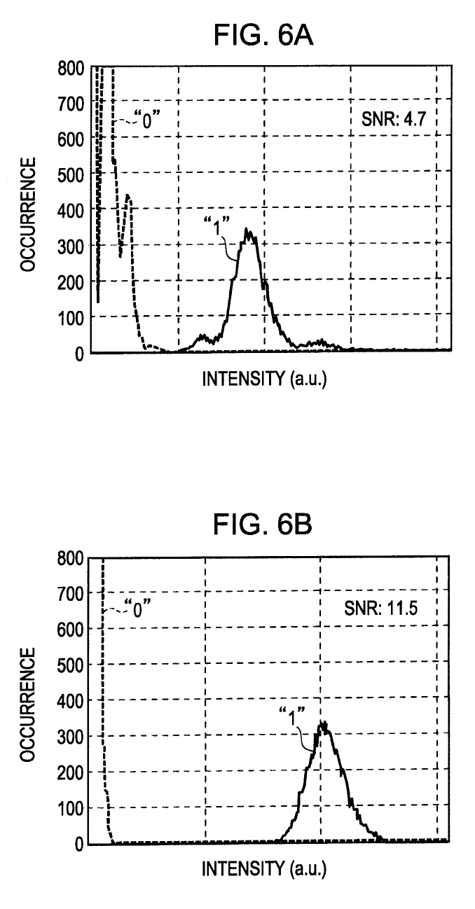

Further, FIGS. 6A and 6B are presented as diagrams for explaining that the recording operation with the use of the optical equalizer 10 improves the reproduction signal characteristic. FIG. 6A shows a simulation result of the reproduction signal characteristic obtained in the absence of the optical equalizer 10. FIG. 6B shows a simulation result of the reproduction signal characteristic obtained in the presence of the optical equalizer 10. Each of the drawings shows, as the reproduction signal characteristic, respective distributions of the code 0 (a broke line) and the code 1 (a solid line) in histograms. The horizontal axis and the vertical axis represent the light intensity and the number of pixels, respectively. The drawings also show calculation results of the SNR (Signal-to-Noise Ratio).

It can be confirmed from the comparison between FIGS. 6A and 6B that a large variation in the distributions of the codes 0 and 1 and a relatively large width of the distributions, which are observed in the result obtained in the absence of the optical equalizer 10, are reduced by the provision of the optical equalizer 10. Further, the SNR is 4.7 in the absence of the optical equalizer 10 and 11.5 in the presence of the optical equalizer 10, i.e., the SNR is improved by approximately 2.5 times by the provision of the optical equalizer 10.

With the recording signal characteristic thus improved by the optical equalizer 10, the reproduction signal characteristic is also improved.

As described above, according to the present embodiment, the optical equalizer 10 is provided to perform the optical equalization for attenuating the low-frequency band components of the signal light. Thereby, the high-frequency band components of the recording light can be relatively emphasized. With this configuration, it is possible to improve the recording signal characteristic deteriorated in the case of performing recording operation by using the aperture 6 wherein the high-frequency components are suppressed. At the same time, it is also possible to improve the signal characteristic deteriorated in the case using the coaxial method wherein the high-frequency components are suppressed due to the intensity distribution of the reference light.

With the signal characteristic thus improved, it is not particularly necessary to perform the related art electrical equalization processing on the reproduction signal for emphasizing the high-frequency components. As described earlier, due to the issue of nonlinearity of a hologram recording and reproducing system, it has been considered substantially difficult to achieve such electrical equalization processing at a practicable level. That is, in this regard, it has been difficult to practically achieve the hologram recording and reproduction. In view of this, the present embodiment, in which the electrical equalization processing is unnecessary as described above, can make it easier to achieve the hologram recording and reproduction at a practical level.

### Second Embodiment

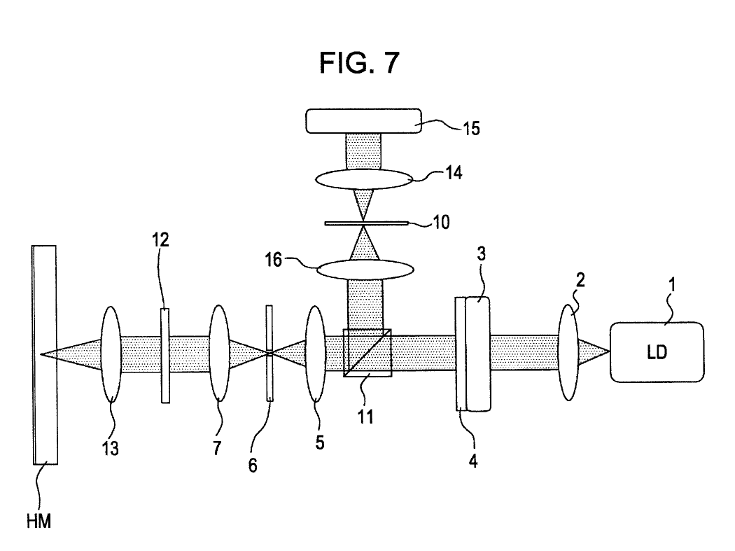

Subsequently, a second embodiment will be described. The second embodiment is configured to perform the equalization by the optical equalizer 10 not in the recording operation but in the reproducing operation. FIG. 7 illustrates an internal configuration of a recording and reproducing device according to the second embodiment. Also in FIG. 7, the configuration of an optical system is mainly extracted and illustrated as the internal configuration of the recording and reproducing device. In the following description, components similar to the components already described will be designated with the same reference numerals, and description thereof will be omitted.

As understood from the comparison between FIG. 7 and the foregoing FIG. 1, in the recording and reproducing device of the second embodiment, the relay lenses 8 and 9 provided in the recording and reproducing device of FIG. 1 are omitted, and the polarizing beam splitter 11 is inserted between the phase mask 4 and the relay lens 5. Also in this case, the light transmitted through the relay lens 5 is sequentially transmitted through the aperture 6, the relay lens 7, the quarter-wave lens 12, and the objective lens 13, and is applied to the hologram recording medium HM.

Further, in this case, the reproduction light obtained from the hologram recording medium HM and reflected by the polarizing beam splitter 11 in the reproducing operation is incident on the lens 16. The lens 16, which forms a zoom lens system together with the lens 14 illustrated also in FIG. 1, adjusts the magnification of the reproduction light in accordance with a predetermined magnification, and guides the reproduction light to the image sensor 15. As illustrated in the drawing, the reproduction light transmitted through the lens 16 is converted into convergent light and focused at a predetermined position. Thereafter, resultant diffused light is converted into parallel light by the lens 14, and is incident on the image sensor 15.

Further, in this case, the optical equalizer 10 is inserted at a position on a focal plane (Fourier plane) formed by the lens 16. That is, with this configuration, the optical equalizer 10 in this case is inserted on a Fourier plane formed in an optical path other than an optical path through which the signal light and the reference light are guided to the hologram recording medium HM in the recording operation. Also in this case, the optical equalizer 10 is provided with the center thereof positioned to match the optical axis center of the incident light.

With the optical equalizer 10 inserted at the above-described position, the equalization by the optical equalizer 10 in this case is performed only on the reproduction light obtained in the reproducing operation. That is, with this equalization, the reproduction signal characteristic is improved in this case.

### Third Embodiment

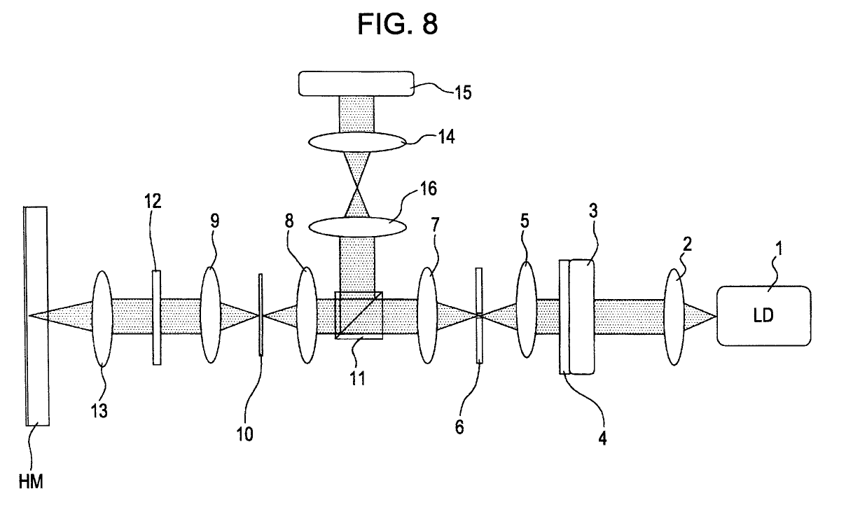

A third embodiment is configured to perform the equalization by the optical equalizer 10 both in the recording operation and the reproducing operation. FIG. 8 is a diagram illustrating an internal configuration of a recording and reproducing device according to the third embodiment. In FIG. 8, the configuration of an optical system is mainly extracted and illustrated. As illustrated in the drawing, in the recording and reproducing device in this case, the laser diode 1, the collimator lens 2, the SLM 3, the phase mask 4, the relay lens 5, the aperture 6, and the relay lens 7 are provided in an arrangement similar to the arrangement of the foregoing FIG. 1. In this case, the light transmitted through the relay lens 7 is incident on the relay lens 8 through the polarizing beam splitter 11.

Further, in this case, the optical equalizer 10 is provided at a position on a focal plane (Fourier plane) formed by the relay lens 8 such that the light transmitted through the optical equalizer 10 is sequentially transmitted through the relay lens 9, the quarter-wave plate 12, and the objective lens 13 and is applied to the hologram recording medium HM. In this case, the reproduction light reflected by the polarizing beam splitter 11 is transmitted through the zoom lens system formed by the lenses 16 and 14 provided in the foregoing example of FIG. 7, and is guided to the image sensor 15.

With the above-described configuration, the optical equalizer 10 in this case is provided at a position on a Fourier plane formed in an area common to the optical path through which the signal light and the reference light are guided to the hologram recording medium HM in the recording operation and the optical path through which the reproduction light is guided to the image sensor 15 in the reproducing operation. With the optical equalizer 10 inserted at the above-described position, the equalization by the optical equalizer 10 in this case can be performed on both the recording light used in the recording operation and the reproduction light obtained from the hologram recording medium HM in the reproducing operation. That is, in this case, the optical equalization can be performed to improve both the recording signal characteristic and the reproduction signal characteristic.

### Fourth Embodiment

Subsequently, a fourth embodiment will be described. Unlike the foregoing embodiments, in which the equalization for emphasizing the high-frequency components is performed on the basis of the intensity modulation performed on the incident light, the fourth embodiment performs the equalization for emphasizing the high-frequency components on the basis of the phase modulation.

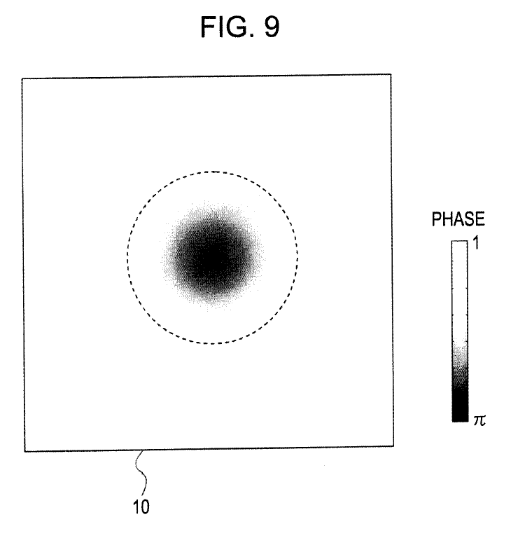

In FIG. 9, which is a diagram for explaining the structure of the optical equalizer 10 in the above-described fourth embodiment, the phase (phase difference) provided to the transmitted light by the optical equalizer 10 is shown in color density.

Specifically, in this case, the phase provided to the transmitted light in the peripheral area is set to be a reference phase 0. Further, the drawing shows a change in phase difference from 0 to π in accordance with a change in color from white to black in the drawing.

As shown in FIG. 9, in this case, the phase modulation is performed such that the phase difference is provided to the transmitted light in the peripheral area and the transmitted light in the central area. Specifically, the phase modulation is performed such that, when the phase in the peripheral area is set to be a reference, the phase difference provided to the transmitted light is gradually (continuously) increased toward the central area.

The structure of the optical equalizer 10 for performing the phase modulation includes a structure which provides a difference in the optical path length to the incident light. Alternatively, a structure formed by the combination of materials of different refractive indices is also conceivable.

Herein, even if the signal light in the recording operation is subjected to the equalization based on the phase modulation performed by the use of the optical equalizer 10 as illustrated in FIG. 9, the effect of improving the signal characteristic is not obtained. That is, in the embodiment, the equalization by the optical equalizer 10 is performed not on a real-image plane (modulation plane of the SLM 3) but on a Fourier plane. Thus, even if necessary phase pattern is provided to the signal light on the Fourier plane, the phase information does not directly affect the hologram recording.

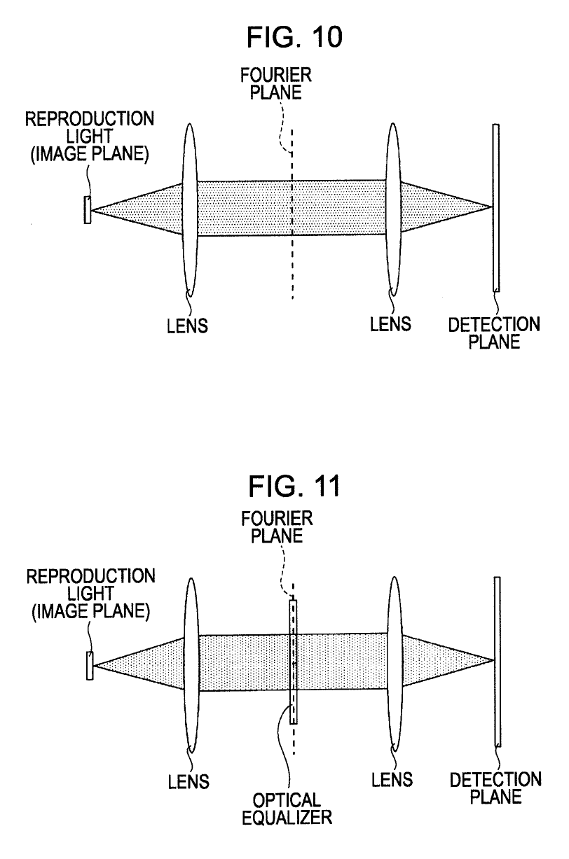

The equalization based on the phase modulation according to the fourth embodiment effectively operates only in the reproducing operation. This point will be described with reference to FIGS. 10 to 14B.

In describing this point, a simplified model as illustrated in FIG. 10 is first presented as an example of the model of a hologram reproducing system. The model illustrated in the drawing is not of the entire reproduction light (signal light) but of a portion of the reproduction light corresponding to one pixel. Herein, in the case in which the recording operation is performed with the signal light provided with the random binary phase pattern, as in the embodiment, an equal distribution characteristic is obtained from the intensity distribution of the light corresponding to one pixel and the intensity distribution of the entire reproduction light (signal light). In view of this, the following description will be made on the basis of the model of the light corresponding to one pixel as illustrated in FIG. 10.

In the model of FIG. 10, the light from each of the pixels in the SLM 3 (i.e., the light from each of the pixels in the reproduction light) is incident on a lens with a certain angle. The incident light is converted by the lens into parallel light (having an intensity distribution). Thereafter, the light is formed into an image on a detection plane (i.e., the image sensor 15) through the other lens.

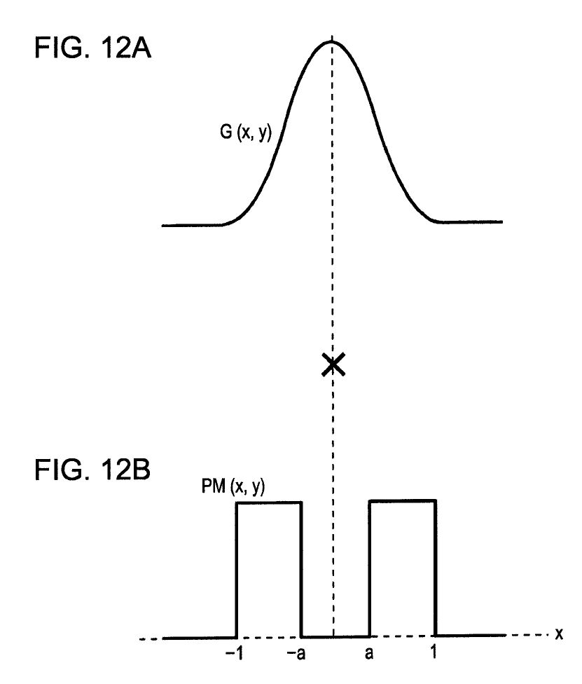

In the above-described model, optical equalization (intensity modulation or phase modulation) performed on a Fourier plane will now be considered. Firstly, as illustrated in the following FIG. 11, the optical equalizer 10 in this case is inserted at a position on the Fourier plane in the model of FIG. 10. Herein, the reproduction light on the Fourier plane has the intensity distribution (amplitude distribution) as illustrated in the following FIG. 12A. In FIG. 12A, the intensity distribution of the reproduction light, which should be illustrated on a two-dimensional plane, is illustrated in a cross-sectional view in a one-dimensional direction, for convenience of illustration. This is based on the assumption that the intensity distributions from the center to the respective directions appear in a substantially similar shape. In fact, the intensity distribution of the reproduction light is assumed to be represented in the shape of G (x, y) illustrated in the drawing. That is, it is assumed that each of the positions on the Fourier plane (two-dimensional plane) is represented by coordinates (x, y), and that the intensities at the respective coordinate positions constitute the intensity distribution.

Meanwhile, the characteristic as illustrated in FIG. 12B is set as the equalization characteristic of the optical equalizer. Also in FIG. 12B, the equalization characteristic, which in fact should be illustrated on a two-dimensional plane, is illustrated in a cross-sectional view in a one-dimensional direction, for convenience of illustration. It is assumed also in this case that each of the positions on the Fourier plane (two-dimensional plane) is represented by coordinates (x, y), and that the equalization characteristic represents the light intensity or the phase at each of the coordinate positions. On the basis of the above description, the equalization characteristic provided by the optical equalizer is represented as PM(x, y) as in the drawing. Herein, a specific characteristic set in this case provides different modulations to an area including the center (pixel center) and ranging from −a to +a (central area) and an area ranging from a to 1 and from −a to −1 (peripheral area).

In this case, in consideration that the equalization is performed on the Fourier plane (frequency plane), the amplitude obtained on the detection plane can be represented as follows.

FT(G(x,y))\textcircled{×}FT(PM(x,y)) Formula 1

In the formula, FT( ) and the circled x mark represent the Fourier transform and the convolution, respectively.

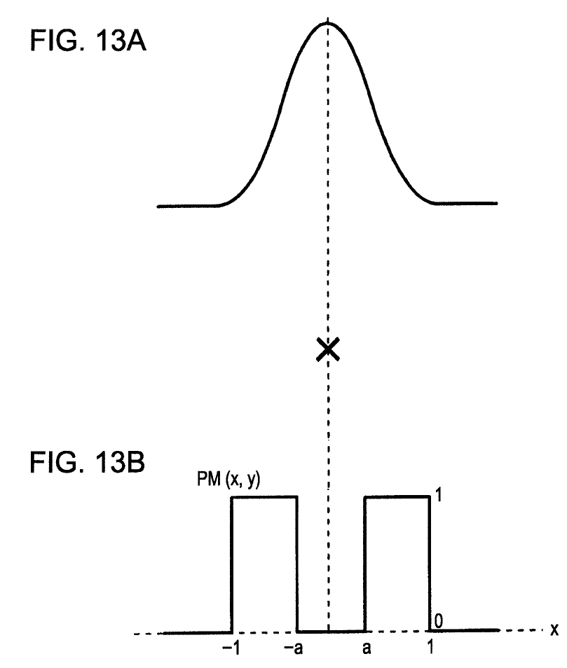

With the above taken into account, consideration will be first given to the example presented in the foregoing first to third embodiments, in which the equalization based on the intensity modulation is performed. In the equalization based on the intensity modulation, it can be considered that light having the intensity distribution as illustrated in FIG. 13A is provided with the equalization characteristic based on the intensity modulation as illustrated in FIG. 13B. Specifically, as illustrated in the drawing, in the equalization characteristic set in this case, the transmittance is 0 in the central area including the center and ranging from −a to +a, and is 1 in the peripheral area ranging from a to 1 and from −a to −1.

Herein, as for the equalization characteristic PM(x, y) based on the intensity modulation illustrated in FIG. 13B, FT(PM(x, y)) representing the characteristic on the Fourier plane is represented as FT_amp. In this case, according to FIG. 13B, the equalization characteristic PM(x, y) can be viewed as the difference resulting from subtraction of “the transmittance 1 in the area from −a to a” from “the transmittance 1 in the area from −1 to 1.” In view of this, the characteristic FT_amp can be represented as follows.

$$\begin{matrix}FT\_amp = FT ( PM ( x , y ) ) \\ = {\int }_{- 1}^{1} \int exp ( i 2 π ( xu + yv ) ) d x d y - \\ {\int }_{- a}^{a} \int exp ( i 2 π ( xu + yv ) ) d x d y \\ = 4 ( sin c ( 2 π u ) sin c ( 2 π v ) - \\ {a}^{2} sin c ( 2 π au ) sin c ( 2 π av ) )\end{matrix} \qquad Formula 2$$

In the formula, i represents an imaginary unit, and u and v represent coordinate values indicating a position on a two-dimensional plane as the detection plane (real-image plane).

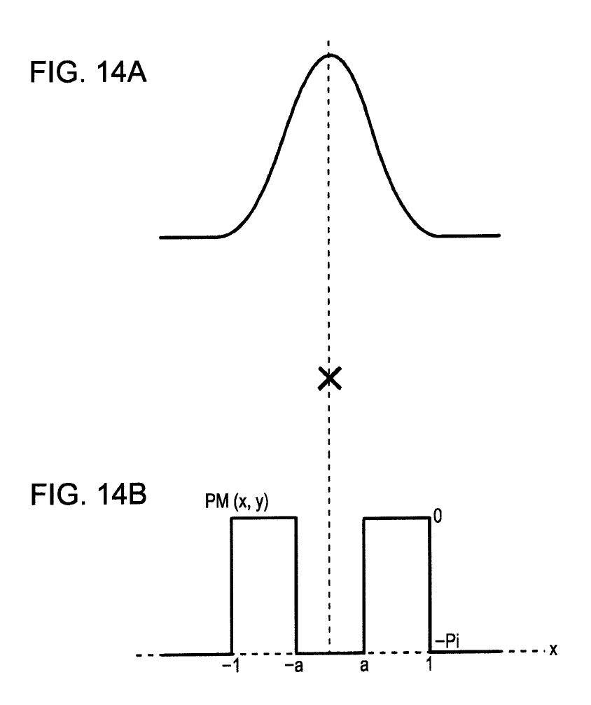

On the basis of the above-described consideration result of the equalization based on the intensity modulation, the equalization based on the phase modulation will be considered with reference to the following FIGS. 14A and 14B. As illustrated in FIGS. 14A and 14B, also in the equalization based on the phase modulation, it can be understood that light having an intensity distribution similar to the intensity distribution of the foregoing FIG. 13A (FIG. 14A) is provided with the equalization characteristic based on the phase modulation as illustrated in FIG. 14B. As illustrated in FIG. 14B, in the equalization characteristic set in this case, the phase is −π in the central area including the center and ranging from −a to +a, and is 0 in the peripheral area ranging from a to 1 and from −a to −1.

Herein, as for the equalization characteristic PM(x, y) based on the phase modulation as illustrated in FIG. 14B, FT(PM(x, y)) representing the characteristic on the Fourier plane is represented as FT_phase. In the characteristic PM(x, y) illustrated in FIG. 14B, the modulation range is set to be the same as the modulation range in the equalization characteristic based on the intensity modulation illustrated in the foregoing FIG. 13B (from −a to +a). In view of this, the equalization characteristic PM(x, y) based on the phase modulation illustrated in FIG. 14B can be viewed as a characteristic which provides the modulation with the light intensity 1 and the phase π in the area ranging from −a to +a in the equalization characteristic based on the intensity modulation illustrated in FIG. 13B, i.e., the area in which the transmittance (light intensity) is 0.

On the basis of the above idea, the characteristic FT_phase can be represented as follows.

$$\begin{matrix}FT\_phase = FT ( PM ( x , y ) ) \\ {\int }_{- 1}^{1} \int exp ( i 2 π ( xu + yv ) ) d x d y - \\ {\int }_{- a}^{a} \int exp ( i 2 π ( xu + yv ) ) d x d y + \\ {\int }_{- a}^{a} \int exp ( i ( - π ) ) exp ( i 2 π ( xu + yv ) ) d x d y \\ = {\int }_{- 1}^{1} \int exp ( i 2 π ( xu + yv ) ) d x d y - \\ {\int }_{- a}^{a} \int exp ( i 2 π ( xu + yv ) ) d x d y + \\ {\int }_{- a}^{a} \int ( - 1 ) exp ( i 2 π ( xu + yv ) ) d x d y \\ = 4 ( sin c ( 2 π u ) sin c ( 2 π v ) - \\ 2 {a}^{2} sin c ( 2 π au ) sin c ( 2 π av ) )\end{matrix} \qquad Formula 3$$

In the above formula, the difference resulting from subtraction of “the transmittance 1 in the area from −a to a” from “the transmittance 1 in the area from −1 to 1,” which is underlined in the equation of the foregoing Formula 2, is added with a term underlined with a broken line, i.e., “the light intensity 1 and the phase π in the area from 'a to a.”

The above-described verification result is summarized below.

FT_amp=4(sinc(2πu)sinc(2πv)−a²sinc(2πau)sinc(2πav)) Formula 4

FT_phase=4(sinc(2πu)sinc(2πv)−2a²sinc(2πau)sinc(2πav)) Formula 5

It can be understood from the above result that the characteristics FT_amp and FT_phase are different only in the term including the underlined coefficient a. As obvious from FIGS. 13B and 14B, the coefficient a is a value which defines the modulation area. Therefore, the difference in the term can be eliminated by a change of the modulation area. According to the result of the above formulae, the equation (a_amp)²=2(a_phase)² holds. Therefore, the equation a_phase=a_amp×1/√2 can be derived. That is, the modulation area set for the equalization based on the phase modulation can be set to be an area reduced to 1/√2 times of the modulation area set for the intensity modulation performed to obtain the same equalization effect.

On the basis of the above consideration, it can be understood that, as for the equalization performed on the reproduction light, the equalization based on the intensity modulation and the equalization based on the phase modulation are basically the same. That is, similarly to the equalization based on the intensity modulation, the equalization based on the phase modulation performed in the reproducing operation effectively operates. As understood from the above description, however, the equalization based on the phase modulation is different from the equalization based on the intensity modulation in that, unlike the equalization based on the intensity modulation which provides the effect of directly limiting the band of the incident light, the equalization based on the phase modulation provides the effect of limiting the band of the signal obtained after the light reception by the image sensor 15.

As the configuration of the recording and reproducing device according to the fourth embodiment for performing the equalization based on the phase modulation in the reproducing operation, a configuration similar to the configuration illustrated in the foregoing FIG. 7, for example, can be used. Alternatively, the configuration illustrated in FIG. 8 can also be used.

### MODIFIED EXAMPLES

Description has been made above of the respective embodiments of the present invention. The present invention, however, should not be limited to the embodiments described above.

For example, the foregoing description has been made of the example in which the transmittance is continuously changed from the peripheral area to the central area in the optical equalizer 10 for performing the equalization based on the intensity modulation. The transmittance, however, may be discontinuously changed. For example, it is possible to set a characteristic which reduces the transmittance from the peripheral area to the central area in a stepwise manner in accordance with a predetermined number of steps. Alternatively, the transmittance can be changed roughly between two values, as in an example in which the transmittance is set to be 1 in the peripheral area and a predetermined transmittance value smaller than 1 in the central area. Further, it is also possible to set a characteristic which does not simply reduce the transmittance from the peripheral area to the central area but increases the transmittance in some areas.

Further, the following intensity modulation characteristic can be provided to mainly emphasize intermediate-frequency components. That is, for example, the area of the optical equalizer 10 is roughly divided into three areas from the center to the outer circumference, i.e., an innermost area closest to the center, an outermost area located outermost, and an intermediate area located therebetween. Then, the transmittance is set to be relatively higher in the outermost area than in the innermost area. Further, in the outermost area, the transmittance is gradually increased from the outside toward the inside. In the intermediate area, the transmittance is set to be higher than in the outermost area. In the innermost area, the transmittance is gradually reduced from the outside toward the inside. According to this configuration, the low-frequency components are attenuated, and the intermediate-frequency components higher than the low-frequency components are emphasized most. Further, the high-frequency components higher than the intermediate-frequency components are gradually attenuated toward the higher-frequency band.

Further, also in the equalization based on the phase modulation, the characteristic of the phase modulation can be changed not only continuously from the peripheral area to the central area but also discontinuously. Further, the phase can be changed between two values in the peripheral area and the central area.

In any case, it suffices if the optical equalizer 10 is configured to be able to provide an equalization characteristic which attenuates the components of a low-frequency band (central area) and thus relatively emphasizes the components of a high-frequency band (peripheral area) higher than the low-frequency band. Therefore, there is no particular limitation on the specific characteristic, as long as the characteristic sets the transmittance to be relatively lower in the central area than in the peripheral area or provides a relative phase difference between the central area and the peripheral area.

Further, the specific structure for performing the intensity modulation or the phase modulation on the incident light by the optical equalizer 10 is not limited to the foregoing examples. Therefore, there is no particular limitation on the specific structure.

Further, the insertion position of the optical equalizer 10 is not limited to the foregoing examples. Therefore, the optical equalizer 10 for performing the equalization based on the intensity modulation can be inserted at a necessary position on a Fourier plane in an optical path. That is, the optical equalizer 10 can be inserted at a position on a Fourier plane in an optical path of the optical system configured to guide the signal light and the reference light to the hologram recording medium HM and to guide to the image sensor 15 the reproduction light obtained from the hologram recording medium HM in accordance with the application of the reference light. With this configuration, the recording signal characteristic or the reproduction signal characteristic can be improved. In any case, it is possible to improve the characteristic of the reproduction signal (readout signal) ultimately obtained through the image sensor 15.

Further, the insertion position of the optical equalizer 10 for performing the equalization based on the phase modulation can be set to be a position on a Fourier plane in the optical path through which the reproduction light obtained from the hologram recording medium HM is guided to the image sensor 15. With this configuration, the reproduction signal characteristic can be improved.

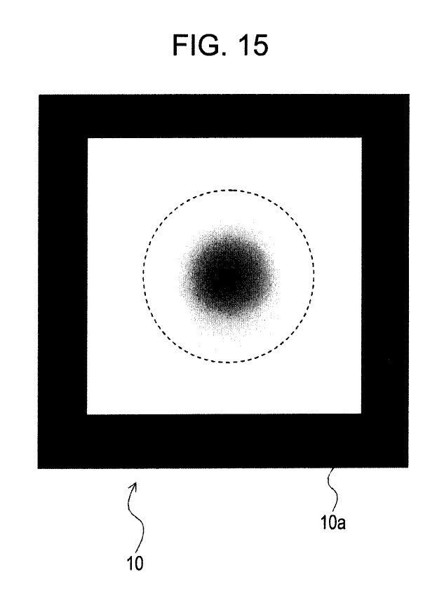

Further, the optical equalizer 10 can be configured to also function as the aperture 6, as illustrated in the following FIG. 15, for example. In the example illustrated in FIG. 15, a light-blocking mask portion 10a having a transmittance of 0 is provided to a predetermined area outside the modulation area (modulation area of the intensity or phase) of the optical equalizer 10 indicated by a broken line. With this configuration, it is possible to reduce the size of the incident light (signal light), and to have the optical equalizer 10 function as the aperture 6. The above-described light-blocking mask portion 10a can be easily formed by vapor deposition or sputtering, for example.

Further, the foregoing description has been made of the example in which the equalization for improving the signal characteristic is performed solely by the equalization by the optical equalizer 10, i.e., the optical equalization. However, it is also possible to perform, in addition to the above-described optical equalization, equalization processing based on signal processing on the light reception signal (readout signal) obtained at the image sensor 15. According to this configuration, the equalization for emphasizing the high-frequency components can be shared by the optical equalizer 10 and the above-described equalization processing. Accordingly, it is possible to reduce the load on the electrical equalization processing, and to substantially simplify the configuration for the equalization processing.

Further, the foregoing description has been made of the example in which the present invention is compatible with the reflection-type hologram recording medium HM including a reflective film. However, the present invention can also be suitably used compatibly with a transmission-type hologram recording medium HM not including a reflective film.

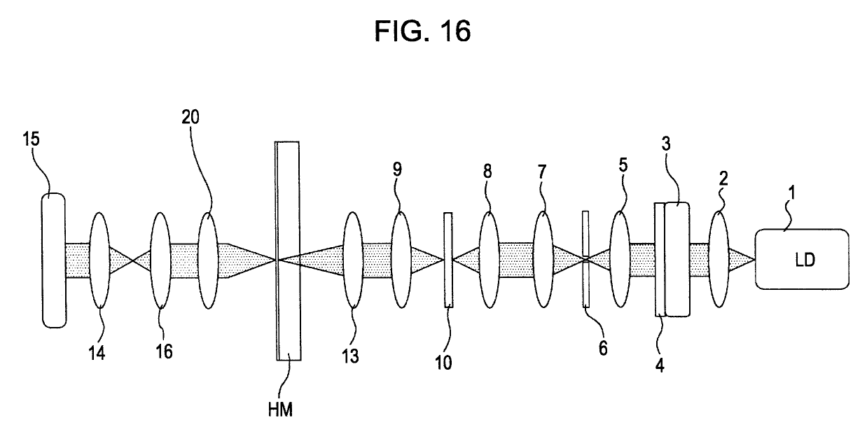

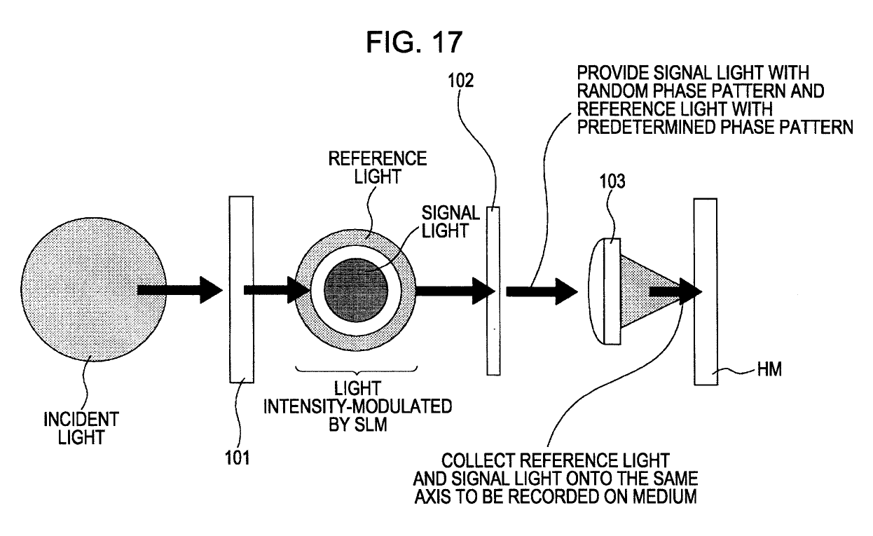

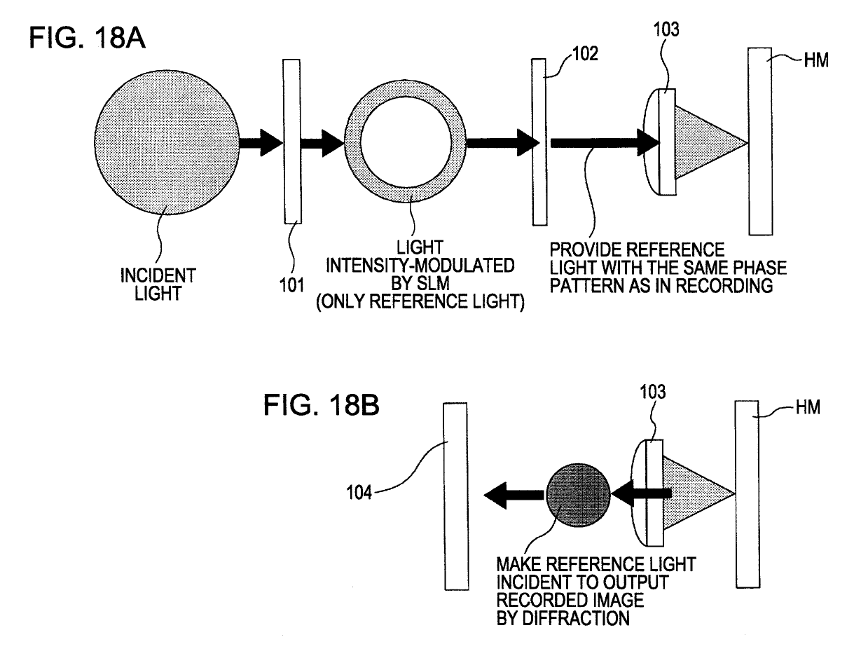

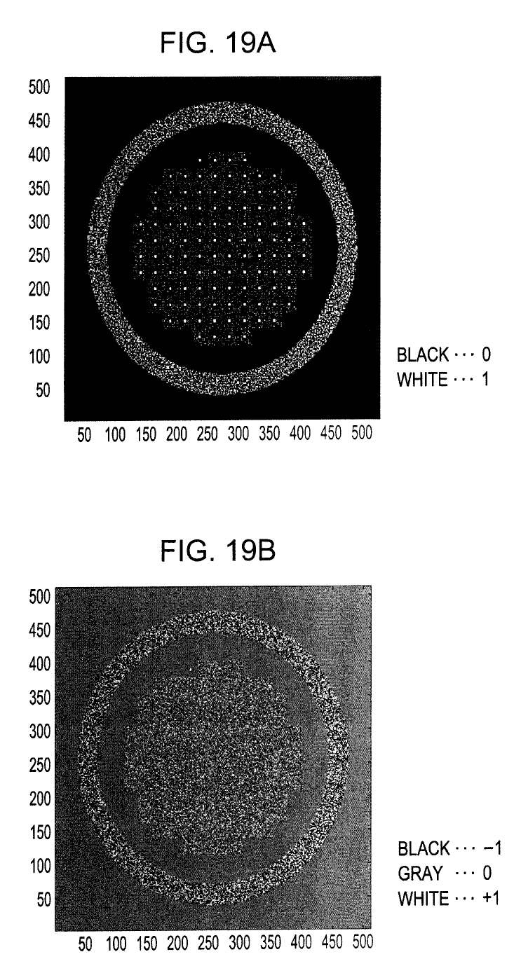

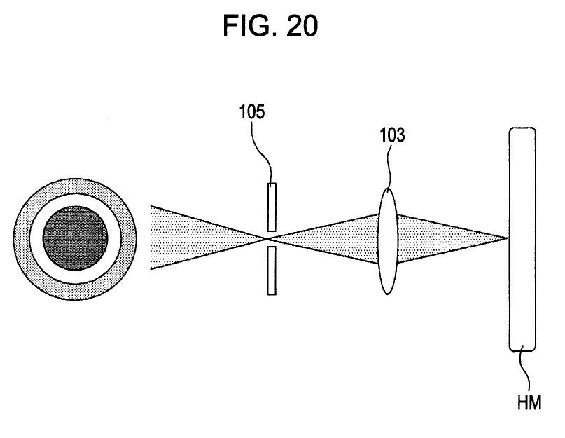

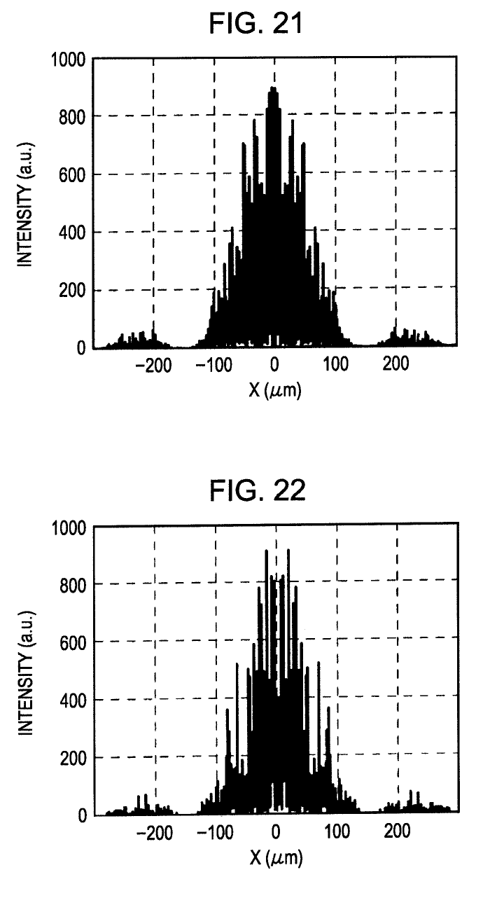

For confirmation, with reference to the following FIG. 16, description will be made of a configuration example of a recording and reproducing device compatible with the above-described transmission-type hologram recording medium HM. In the configuration of FIG. 16 compatible with the transmission-type hologram recording medium HM, the reproduction light is obtained not as the light reflected by the hologram recording medium HM but as the light transmitted through the hologram recording medium HM. In this case, the recording and reproducing device is configured to detect the reproduction light obtained as the transmitted light at a position on the opposite side of a laser light incident surface of the hologram recording medium HM.

FIG. 16 illustrates, as a specific configuration, the configuration of the foregoing FIG. 1 (the configuration for performing the optical equalization in the recording operation) modified to be compatible with the transmission-type medium. In the configuration illustrated in FIG. 16, the polarizing beam splitter 11 and the quarter-wave plate 12 included in the configuration of FIG. 1 are omitted. In this case, a condenser lens 20 is provided at a position in the rear of the hologram recording medium HM as viewed from the laser diode 1 serving as the light source. The condenser lens 20 converts the reproduction light obtained as the transmitted light from the hologram recording medium HM into parallel light. The reproduction light transmitted through the condenser lens 20 is adjusted in magnification through the zoom lens system formed by the lenses 16 and 14 similar to the lenses in the foregoing FIG. 7, and is guided to the image sensor 15.

For confirmation, also in the above-described configuration compatible with the transmission-type medium, the basic recording and reproducing operations are similar to the recording and reproducing operations performed in the configuration compatible with the reflection-type medium. Therefore, the configuration compatible with the transmission-type medium is the same as the configuration compatible with the reflection-type medium in that the signal light and the reference light are applied in the recording operation to record data on the hologram recording medium HM by using the interference fringes formed by the lights, and that the reference light is applied to the hologram recording medium HM in the reproducing operation to detect the resultant reproduction light at the image sensor 15.

Further, the foregoing description has been made of the example in which a transmission-type spatial light modulator is used as the SLM 3. However, it is also possible to use, as the SLM 3, a reflection-type spatial light modulator such as a DMD (Digital Micromirror Device: registered trademark) and a reflection-type liquid crystal panel.

Further, the foregoing description has been made of the example in which the ring-shaped reference light area Al having the same center as the center of the circular signal light area A1 is provided outside the signal light area A2. However, the respective shapes of the signal light area A2 and the reference light area A1 are not limited to the circular shape and the ring shape, respectively, as long as the two areas are arranged to have the same center. It is also possible to provide the reference light area A1 and the signal light area A2 on the inner side and the outer side, respectively.

Further, the foregoing description has been made of the example in which the coaxial method is used as the hologram recording and reproducing method. However, the present invention can also be suitably applied to an example using a two-beam method, in which the signal light and the reference light are not disposed on the same axis. As widely known, in the two-beam method, two systems are separately provided, i.e., a system which applies to the hologram recording medium HM the signal light generated by spatial light modulation according to the recorded data performed on the light from the light source by the spatial light modulator, and a system which generates the reference light on the basis of the light from the light source and applies the reference light to the hologram recording medium HM.

In this case, a light generation device in an embodiment of the present invention includes a signal light generation unit and a reference light generation unit. The signal light generation unit includes a spatial light modulator which generates the signal light by performing spatial light modulation according to the recorded data on the light from the light source. The reference light generation unit generates the reference light of a predetermined shape on the basis of the light from the light source.

For confirmation, with the use of the two-beam method, it is possible to avoid the issue of deterioration of the signal characteristic due to the intensity distribution of the reference light, which arises in the case using the coaxial method. With the use of the two-beam method, therefore, it is possible to improve the signal characteristic in the case in which an aperture is provided to increase the recording density.

Further, the foregoing description has been made of the example in which the present invention is applied to the recording and reproducing device for performing the recording and reproducing operations on the hologram recording medium. The present invention, however, can also be suitably applied to a recording device capable of performing only the recording operation, and to a reproducing device capable of performing only the reproducing operation. In the recording device, the configuration of the reproducing system (the polarizing beam splitter 11, the quarter-wave plate 12, the image sensor 15, and the lenses 14 and 16) can be omitted from the configuration of the optical system. In this case, the optical equalizer 10 can be provided at a necessary position on a Fourier plane in the optical path of the optical system. With this configuration, the recording signal characteristic can be improved. Further, in the reproducing device, the aperture 6 can be omitted. In the reproducing device, the optical equalizer 10 can be provided at a necessary position on a Fourier plane in the optical path through which the reproduction light obtained from the hologram recording medium HM is guided to the image sensor 15. With this configuration, the reproduction signal characteristic can be improved.

The present application contains subject matter related to that disclosed in Japanese Priority Patent Application JP 2008-132065 filed in the Japan Patent Office on May 20, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1.-11. (canceled)

12. A recording and reproducing method for performing recording and reproducing operations on a hologram recording medium on which data is recorded by the use of interference fringes formed by signal light and reference light, the recording and reproducing method comprising the step of:
performing, at a position on a Fourier plane in an optical path of an optical system configured to guide the signal light and the reference light to the hologram recording medium in the recording operation and to make an image sensor receive reproduction light obtained from the hologram recording medium in accordance with the application of the reference light in the reproducing operation, band limitation on incident light by using a band limiting means device having a transmittance set to be lower in a central area thereof than in a peripheral area thereof.

13. A recording device for performing a recording operation on a hologram recording medium on which data is recorded by the use of interference fringes formed by signal light and reference light, the recording device comprising:
light generation means, including a spatial light modulator which performs spatial light modulation on incident light in units of pixels, for generating the signal light and the reference light;
an optical system configured to guide to the hologram recording medium the signal light and the reference light generated by the light generation means; and
band limiting means, inserted at a position on a Fourier plane in an optical path of the optical system, and having a transmittance set to be lower in a central area thereof than in a peripheral area thereof, for performing band limitation on the incident light.

14. A recording method for performing a recording operation on a hologram recording medium on which data is recorded by the use of interference fringes formed by signal light and reference light, the recording method comprising the step of:
performing, at a position on a Fourier plane in an optical path of an optical system configured to guide the signal light and the reference light to the hologram recording medium, band limitation on incident light by using a band limiting device having a transmittance set to be lower in a central area thereof than in a peripheral area thereof.

15. (canceled)

16. A reproducing method for performing a reproducing operation on a hologram recording medium on which data is recorded by the use of interference fringes formed by signal light and reference light, the reproducing method comprising the step of:
performing, at a position on a Fourier plane in an optical path of an optical system configured to guide the reference light to the hologram recording medium and to make an image sensor receive reproduction light obtained from the hologram recording medium in accordance with the application of the reference light, band limitation on incident light by using a band limiting device having a transmittance set to be lower in a central area thereof than in a peripheral area thereof.

17.-24. (canceled)

25. A recording and reproducing method for performing recording and reproducing operations on a hologram recording medium on which data is recorded by the use of interference fringes formed by signal light and reference light, the recording and reproducing method comprising the step of:
performing, at a position on a Fourier plane in an optical path of an optical system configured to guide the signal light and the reference light to the hologram recording medium in the recording operation and to make an image sensor receive reproduction light obtained from the hologram recording medium in accordance with the application of the reference light in the reproducing operation, spatial light phase modulation on incident light to perform band limitation on a light reception signal obtained at the image sensor.

26. (canceled)

27. A reproducing method for performing a reproducing operation on a hologram recording medium on which data is recorded by the use of interference fringes formed by signal light and reference light, the reproducing method comprising the step of:
performing, at a position on a Fourier plane in an optical path of an optical system configured to guide the reference light to the hologram recording medium and to make an image sensor receive reproduction light obtained from the hologram recording medium in accordance with the application of the reference light, spatial light phase modulation on incident light to perform band limitation on a light reception signal obtained at the image sensor.

28. (canceled)

29. A recording device for performing a recording operation on a hologram recording medium on which data is recorded by the use of interference fringes formed by signal light and reference light, the recording device comprising:
a light generation device configured to include a spatial light modulator which performs spatial light modulation on incident light in units of pixels, and to generate the signal light and the reference light;
an optical system configured to guide to the hologram recording medium the signal light and the reference light generated by the light generation device; and
a band limiting device configured to be inserted at a position on a Fourier plane in an optical path of the optical system, and to have a transmittance set to be lower in a central area thereof than in a peripheral area thereof, to perform band limitation on the incident light.

30. A reproducing device for performing a reproducing operation on a hologram recording medium on which data is recorded by the use of interference fringes formed by signal light and reference light, the reproducing device comprising:
a light generation device configured to generate the reference light;
an image sensor configured to receive incident light in units of pixels and obtain a light reception signal;
an optical system configured to guide to the hologram recording medium the reference light generated by the light generation device, and to guide to the image sensor reproduction light obtained from the hologram recording medium in accordance with the application of the reference light; and
a band limiting device configured to be inserted at a position on a Fourier plane in an optical path of the optical system, and to have a transmittance set to be lower in a central area thereof than in a peripheral area thereof, to perform band limitation on the incident light.

31. (canceled)

32. A reproducing device for performing a reproducing operation on a hologram recording medium on which data is recorded by the use of interference fringes formed by signal light and reference light, the reproducing device comprising:
a light generation device configured to generate the reference light;
an image sensor configured to receive incident light in units of pixels and obtain a light reception signal;
an optical system configured to guide to the hologram recording medium the reference light generated by the light generation device, and to guide to the image sensor reproduction light obtained from the hologram recording medium in accordance with the application of the reference light; and
a band limiting device configured to be inserted at a position on a Fourier plane in an optical path of the optical system, and to perform spatial light phase modulation on the incident light to perform band limitation on the light reception signal obtained at the image sensor.

33. The recording and reproducing device according to claim 29,
wherein the light generation device performs, on incident lights emitted from the same light source, the spatial light modulation by the spatial light modulator common to the incident lights, to thereby generate the signal light and the reference light disposed on the same optical axis.

34. The recording and reproducing device according to claim 33,
wherein the optical system is configured such that the Fourier plane is formed in an optical path other than an optical path through which the reproduction light is guided to the image sensor in the reproducing operation, and
wherein the band limiting device is inserted on the Fourier plane.

35. The recording and reproducing device according to claim 33,
wherein the optical system is configured such that the Fourier plane is formed in an optical path other than an optical path through which the signal light and the reference light are guided to the hologram recording medium in the recording operation, and
wherein the band limiting device is inserted on the Fourier plane.

36. The recording and reproducing device according to claim 33,
wherein the optical system is configured such that the Fourier plane is formed in an area common to an optical path through which the signal light and the reference light are guided to the hologram recording medium in the recording operation and
an optical path through which the reproduction light is guided to the image sensor in the reproducing operation, and
wherein the band limiting device is inserted on the Fourier plane.

37. The recording and reproducing device according to claim 33,
wherein the band limiting device is configured such that the transmittance is continuously changed from the peripheral area to the central area.

38. The recording and reproducing device according to claim 33,
wherein the band limiting device is configured such that the transmittance is discontinuously changed from the peripheral area to the central area.

39. The recording and reproducing device according to claim 33,
wherein the band limiting device is configured such that:
the transmittance is changed between two values in the peripheral area and the central area.

40. The recording and reproducing device according to claim 33,
wherein the band limiting device is configured such that, in three areas of first to third areas sequentially formed from the center toward the outer circumference thereof, the transmittance is lower in the first area than in the second area and is approximately zero in the third area.

41. The recording and reproducing device according to claim 33,
wherein the band limiting device is configured such that, in three areas of first to third areas sequentially formed from the center toward the outer circumference thereof, the transmittance is higher in the second area than in the first and third areas.

42. The recording and reproducing device according to claim 29,
wherein the optical system is configured to guide, through separate optical paths, the signal light and the reference light generated by the light generation device to the hologram recording medium.
